(19) United States
(12) Patent Application Publication
(10) Pub. No.: US 2026/0011474 A1
(43) Pub. Date: Jan. 8, 2026

(54) MAGNETIC COMPONENT

(71) Applicant: SAMSUNG ELECTRO-MECHANICS CO., LTD., Suwon-si (KR)

(72) Inventors: Woong Sup LEE, Suwon-si (KR); Jae Hee JU, Suwon-si (KR); Seok Hee LEE, Suwon-si (KR); Su Rim BAE, Suwon-si (KR); Ji Min KIM, Suwon-si (KR); Min Seon KWON, Suwon-si (KR); Joong Won PARK, Suwon-si (KR); Il Jin PARK, Suwon-si (KR); Hyo Ki HONG, Suwon-si (KR); Hyeon A MUN, Suwon-si (KR); Jong Ok JEON, Suwon-si (KR); Yong Sung KIM, Suwon-si (KR)

(73) Assignee: SAMSUNG ELECTRO-MECHANICS CO., LTD., Suwon-si (KR)

(21) Appl. No.: 19/209,364

(22) Filed: May 15, 2025

(30) Foreign Application Priority Data
Jul. 2, 2024 (KR) 10-2024-0087183
Dec. 30, 2024 (KR) 10-2024-0201144

(51) Int. Cl. H01F 1/24; H01F 1/33; H01F 1/36; H01F 27/255

(52) U.S. Cl. CPC H01F 1/24; H01F 1/33; H01F 1/36; H01F 27/255

(57) ABSTRACT

A magnetic component includes a magnetic body, wherein the magnetic body includes a plurality of first magnetic particles including an Fe component and a plurality of second magnetic particles including an Fe component and having an average particle diameter smaller than an average particle diameter of the plurality of first magnetic particles, at least some of the plurality of first magnetic particles include a first layer formed on a surface and a second layer formed on a surface of the first layer, at least some of the plurality of second magnetic particles include a first layer formed on a surface, the first layer of the first magnetic particles includes Fe oxide, the second layer of the first magnetic particles includes Si oxide, and the first layer of the second magnetic particles includes P oxide.

### CROSS-REFERENCE TO RELATED APPLICATION(S)

This application claims benefit of priority to Korean Patent Application Nos. 10-2024-0087183 filed on Jul. 2, 2024 and 10-2024-0201144 filed on Dec. 30, 2024 in the Korean Intellectual Property Office, the disclosures of which are incorporated herein by reference in their entirety.

### TECHNICAL FIELD

The present disclosure relates to a magnetic component.

As electronic devices, such as digital TVs, mobile phones, and laptops have become smaller and thinner, magnetic components applied to such electronic devices have also been required to be smaller and thinner, and various types of magnetic components have been used to meet these requirements. An example of a magnetic component includes an inductor including a coil, and research and development on coil type or thin film type have been actively conducted.

The main issue with the miniaturization and thinning of magnetic components is to implement characteristics equivalent to those of existing components despite such miniaturization and thinning. In order to meet these requirements, the ratio of a magnetic material in a core filled with the magnetic material has to be increased, but there is a limit to increasing the ratio due to reasons, such as changes in frequency characteristics according to the strength and insulation of a magnetic body.

As an example of manufacturing a magnetic component, a method of laminating a sheet including a mixture of magnetic particles and a resin, etc. and then pressing the same to implement a body has been used, and here, ferrite or metal, etc. may be used as the magnetic particles. In the case of using magnetic metal particles, it is advantageous to increase the particle content in terms of permeability characteristics of magnetic components, etc., but in this case, the insulation of the magnetic body may deteriorate and eddy current loss may occur. Therefore, in the art, it is necessary to sufficiently secure surface insulation of the magnetic particles to prevent the deterioration of the characteristics of the magnetic component.

### SUMMARY

An aspect of the present disclosure is to improve the characteristics of a magnetic component by improving eddy current loss characteristics, structural stability, etc. of a magnetic body including magnetic particles.

According to an aspect of the present disclosure, a magnetic component includes a magnetic body, wherein the magnetic body includes a plurality of first magnetic particles including an Fe component and a plurality of second magnetic particles including an Fe component and having an average particle diameter smaller than an average particle diameter of the plurality of first magnetic particles, at least some of the plurality of first magnetic particles include a first layer formed on a surface and a second layer formed on a surface of the first layer, at least some of the plurality of second magnetic particles include a first layer formed on a surface, the first layer of the first magnetic particles includes Fe oxide, the second layer of the first magnetic particles includes Si oxide, and the first layer of the second magnetic particles includes P oxide.

An average particle diameter of the first magnetic particles may be 15 μm to 35 μm.

An average thickness of the second layer of the first magnetic particles may be 5 nm to 35 nm.

The first layer of the first magnetic particles may include less than 1 wt % of a Si component.

The second layer of the first magnetic particles may include 30 to 70 wt % of a Si component.

The second layer of the first magnetic particles may not include a Sn component.

An average particle diameter of the second magnetic particles may be 0.9 μm to 4.5 μm.

An average thickness of the first layer of the second magnetic particles may be 5 nm to 15 nm.

The first layer of the second magnetic particles may include phosphate.

The first magnetic particles may further include a third layer formed on a surface of the second layer.

The third layer may include at least one functional group among an alkyl group, a carbonyl group, and a urethane acrylate.

An average thickness of the third layer may be less than 10 nm.

The first magnetic particles may include an Fe—Si—Cr alloy.

The magnetic body may include an Fe component and further include a plurality of third magnetic particles having an average particle diameter smaller than an average particle diameter of the plurality of second magnetic particles.

The average particle diameter of the third magnetic particles may be 5 nm to 800 nm.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view illustrating a magnetic component according to an embodiment of the present disclosure;

FIG. 2 is a cross-sectional view of a region of the magnetic component of FIG. 1;

FIG. 3 is an enlarged view of a region of a magnetic body in the magnetic component of FIG. 1;

FIG. 4 illustrates a second magnetic particle that may be employed in the magnetic component;

FIG. 5 illustrates a first magnetic particle that may be employed in a magnetic component;

FIG. 6 is an enlarged view of a region of a magnetic body of a magnetic component according to a modified example;

FIG. 7 illustrates a third magnetic particle that may be employed in a magnetic component;

FIG. 8 is a schematic perspective view illustrating a magnetic component according to another embodiment of the present disclosure;

FIG. 9 is a schematic exploded perspective view of the magnetic component of FIG. 8; and

FIG. 10 is a cross-sectional view of a region of the magnetic component of FIG. 8.

### DETAILED DESCRIPTION

Hereinafter, exemplary embodiments of the present inventive concept will be described in detail with reference to the accompanying drawings. The inventive concept may, however, be exemplified in many different forms and should not be construed as being limited to the specific embodiments set forth herein. Rather, these embodiments are provided so that the present disclosure will be thorough and complete, and will fully convey the scope of the inventive concept to those skilled in the art. In the drawings, the shapes and dimensions of elements may be exaggerated for clarity, and the same reference numerals will be used throughout to designate the same or like elements.

Electronic devices use various types of electronic components, and various types of magnetic components may be appropriately used between these electronic components for purposes, such as noise removal. That is, magnetic components in electronic devices may be used as power inductors, high-frequency inductors (HF inductors), general beads, high-frequency beads (GHz beads), common mode filters, etc.

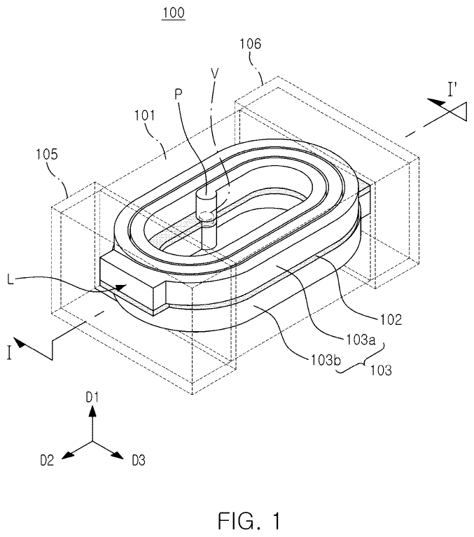

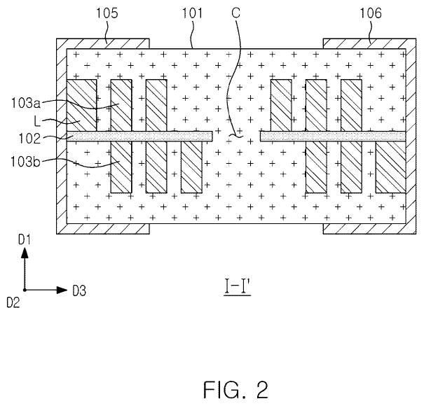

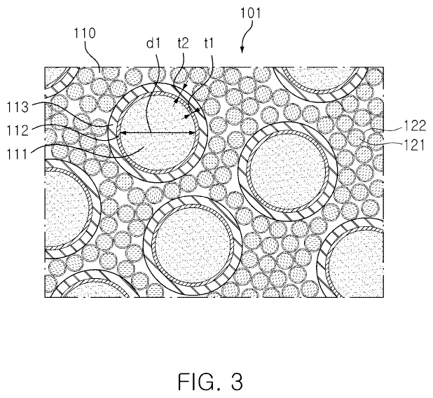

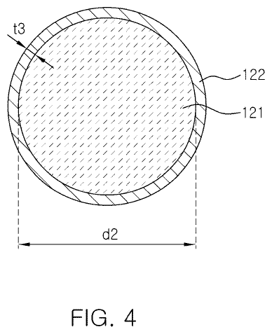

FIG. 1 is a schematic perspective view illustrating a magnetic component according to an embodiment of the present disclosure. FIG. 2 is a cross-sectional view of a region of the magnetic component of FIG. 1. FIG. 3 is an enlarged view of a region of the magnetic body in the magnetic component of FIG. 1. FIG. 4 illustrates a second magnetic particle that may be employed in a magnetic component.

Referring to FIGS. 1 to 4, a magnetic component 100 according to the present embodiment may include a magnetic body 101 including a plurality of magnetic particles, and the plurality of magnetic particles may include a plurality of first magnetic particles 111 and a plurality of second magnetic particles 121. Here, an average particle diameter d2 of the plurality of second magnetic particles 121 may be smaller than an average particle diameter d1 of the plurality of first magnetic particles 111. In addition, at least one of the first magnetic particles 111 of the plurality of first magnetic particles 111 may include a first layer 112 formed on a surface of a core of the first magnetic particles and a second layer 113 formed on a surface of the first layer 112. In some embodiments, at least one of the second magnetic particles 121 of the plurality of second magnetic particles 121 may include a first layer 122 formed on a surface of a core of the second magnetic particles 121. In the present embodiment, the first magnetic particles 111 and the second magnetic particles 121 having different average particle diameters to each other may have different insulating structures formed on the surfaces thereof. Specifically, the first layer 112 of the first magnetic particles 111 may include an Fe oxide, and the second layer 113 of the first magnetic particles 111 includes a Si oxide. In addition, the first layer 122 of the second magnetic particles 121 may include a P oxide. The first magnetic particles 111 having a relatively large particle diameter may have a significant influence on the insulating properties of the magnetic body 101, and the insulating properties of the first magnetic particles 111 may increase through the insulating structures of the first layer 112 and the second layer 113, particularly, the second layer 113 including the Si oxide. In addition, when the second magnetic particle 121 has a relatively small particle diameter, a plurality of the second magnetic particle 121 would exhibit a large specific surface area, and thus an insulating layer having excellent wettability with the insulating material 110 of the magnetic body 101, i.e., the first layer 122 including a P oxide, is used. With this insulating structure, the magnetic body 101 may have improved eddy current loss characteristics, structural stability, etc. Hereinafter, the main components constituting the magnetic component 100 of the present embodiment will be described.

The magnetic body 101 forms an outer appearance of the magnetic component 100, and a coil 103 and a support member 102 supporting the coil 103 may be arranged inside the magnetic body. As illustrated in FIG. 3, these magnetic particles 111 may be dispersed inside the insulating material 110. The insulating material 110 may include a dispersant, a binder, etc., and may include, for example, a polymer component, such as an epoxy resin or a polyimide. The magnetic body 101 may be formed in an overall hexahedral shape. According to some embodiments, the magnetic component 100 in which external electrodes 105 and 106 is disposed on the magnetic body 101 may have a length of 2.5 mm, a width of 2.0 mm, and a thickness of 1.0 mm, or a length of 2.0 mm, a width of 1.2 mm, and a thickness of 0.65 mm, or a length of 1.6 mm, a width of 0.8 mm, and a thickness of 0.8 mm, or a length of 1.0 mm, a width of 0.5 mm, and a thickness of 0.5 mm, or a length of 0.8 mm, a width of 0.4 mm, and a thickness of 0.65 mm, but is not limited thereto. Meanwhile, the aforementioned numerical values are merely design numerical values that do not reflect process errors, etc., and therefore, it should be considered that a range that may be recognized as a process error falls within the scope of the present disclosure.

The first direction D1 length of the magnetic component 100 described above may refer to, based on an optical microscope or scanning electron microscope (SEM) photograph of a first direction D1-third direction D3 cross-section at the center of the magnetic component 100 in the second direction D2, the maximum value among dimensions of each of a plurality of line segments being parallel to the first direction D1 and connecting two outermost boundary lines of the magnetic component 100 illustrated in the cross-sectional photograph facing each other in the first direction D1. Alternatively, it may refer to the minimum value among the dimensions of each of the plurality of line segments being parallel to the first direction D1 and connecting two outermost boundary lines of the magnetic component 100 illustrated in the cross-sectional photograph facing each other in the first direction D1. Alternatively, it may refer to an arithmetic mean value of at least three or more dimensions of each of the plurality of line segments being parallel to the first direction D1 and connecting two outermost boundary lines of the magnetic component 100 illustrated in the cross-sectional photograph facing each other in the first direction D1. Here, the plurality of line segments parallel to the first direction D1 may be equally spaced apart from each other in the third direction D3, but the scope of the present disclosure is not limited thereto.

The second direction D2 length of the magnetic component 100 described above may refer to, based on an optical microscope or scanning electron microscope (SEM) photograph of a first direction D1-second direction D2 cross-section at the center of the magnetic component 100 in the third direction D3, the maximum value among dimensions of each of a plurality of line segments being parallel to the second direction D2 and connecting two outermost boundary lines of the magnetic component 100 illustrated in the cross-sectional photograph facing each other in the second direction D2. Alternatively, it may refer to the minimum value among the dimensions of each of the plurality of line segments being parallel to the second direction D2 and connecting two outermost boundary lines of the magnetic component 100 illustrated in the cross-sectional photograph facing each other in the second direction D2. Alternatively, it may refer to an arithmetic mean value of at least three or more dimensions of each of the plurality of line segments being parallel to the second direction D2 and connecting two outermost boundary lines of the magnetic component 100 illustrated in the cross-sectional photograph facing each other in the second direction D2. Here, the plurality of line segments parallel to the second direction D2 may be equally spaced apart from each other in the first direction D1, but the scope of the present disclosure is not limited thereto.

The third direction D3 length of the magnetic component 100 described above may refer to, based on an optical microscope or scanning electron microscope (SEM) photograph of a first direction D1-third direction D3 cross-section at the center of the magnetic component 100 in the second direction D2, the maximum value among dimensions of each of a plurality of line segments being parallel to the third direction D3 and connecting two outermost boundary lines of the magnetic component 100 illustrated in the cross-sectional photograph facing each other in the third direction D3. Alternatively, it may refer to the minimum value among the dimensions of each of the plurality of line segments being parallel to the third direction D3 and connecting two outermost boundary lines of the magnetic component 100 illustrated in the cross-sectional photograph facing each other in the third direction D3. Alternatively, it may refer to an arithmetic mean value of at least three or more dimensions of each of the plurality of line segments being parallel to the third direction D3 and connecting two outermost boundary lines of the magnetic component 100 illustrated in the cross-sectional photograph facing each other in the third direction D3. Here, the plurality of line segments parallel to the third direction D3 may be equally spaced apart from each other in the first direction D1, but the scope of the present disclosure is not limited thereto.

Meanwhile, each of the lengths of the magnetic component 100 in the first to third directions D1-D3 may be measured by a micrometer measurement method. The micrometer measurement method may be performed by setting a zero point with a Gage R&R (Repeatability and Reproducibility) micrometer, inserting the magnetic component 100 according to the present embodiment between tips of the micrometer, and turning a measurement lever of the micrometer. Meanwhile, when measuring the length of the magnetic component 100 using the micrometer measurement method, the length of the magnetic component 100 may refer to a value measured once or may refer to an arithmetic mean of values measured a plurality of times.

Referring to FIG. 3, the magnetic body 101 includes a plurality of first magnetic particles 111 including an Fe component and a plurality of second magnetic particles 121 including an Fe component. For the purpose of reducing eddy current loss, at least one of the plurality of first magnetic particles 111 may include the first layer 112 formed on the surface and the second layer 113 formed on the surface of the first layer 112, and at least some of the plurality of second magnetic particles 121 include the first layer 112 formed on the surface of the core of the second magnetic particles 121. The plurality of first magnetic particles 111 may have an average particle diameter d1 of about 15 μm to 35 μm. In addition, the plurality of second magnetic particles 121 may have an average particle diameter d2 of about 0.9 μm to 4.5 μm. The average particle diameter d1 of the first magnetic particles 111 and the average particle diameter d2 of the second magnetic particles 112 may be obtained, for example, from an image of a cross-section of the magnetic body 101. As a specific example, the first direction-third direction (D1-D3) cross-section cut in the middle of the magnetic body 101 in the second direction D2 may be imaged using a scanning electron microscope, and then an image analysis program may be used, and the average particle diameter d1 and the average particle diameter d2 may be average values for five or more first magnetic particles 111 and five or more second magnetic particles 121, respectively. In addition, the particle diameter d1 of the first magnetic particle 111 and the particle diameter d2 of the second magnetic particle 121 may be the major axis lengths of the respective particles 111 and 121. However, in some cases, the area of the magnetic particles 111 and 121 may be calculated from the cross-section of the magnetic body 101 and then converted into an equivalent circle diameter. In this case, since an outer region of the magnetic body 101 may be deformed by a pressing process or the like, the particle diameters d1 and d2 of the first and second magnetic particles 111 and 121 may be measured excluding the outer region. For example, a region corresponding to a length within 5% or 10% of the length of the magnetic body from the surface of the magnetic body 101 may be excluded. The particle diameter d1 of the first magnetic particle 111 and the particle diameter d2 of the second magnetic particle 121 may not be obtained from only one cross-section of the magnetic body 101 and may be calculated by averaging a plurality of values obtained from a plurality of cross-sections. Here, the plurality of cross-sections of the magnetic body 101 may be taken at regular intervals in one direction. This method of measurement through a cross-sectional image of the magnetic body 101 may also be applied to the diameter of a third magnetic particle, the thickness of the surface insulating films, the uniformity, etc., which are described below.

According to some embodiments, the magnetic body 101 may be formed by a lamination method. Specifically, the coil 103 may be formed on the support member 102 using a method, such as plating, and then a plurality of unit laminates for manufacturing the magnetic body 101 may be prepared and laminated. Here, the unit laminate may be manufactured by mixing magnetic particles 111, such as a metal, and an organic substance, such as a thermosetting resin, a binder, and a solvent to prepare a slurry and applying the slurry to a carrier film with a thickness of several tens of μm using a doctor blade method and then drying the same to manufacture a sheet. Accordingly, the unit laminate may be manufactured in a form in which the magnetic particles are dispersed in a thermosetting resin, such as an epoxy resin or polyimide. Also, the first magnetic particle 111 and the second magnetic particle 121 may have the form described above, and the first layer 112 and the second layer 113 may be formed on the surface of the first magnetic particle 111, and the first layer 122 may be formed on the surface of the second magnetic particle 121. The aforementioned unit laminates may be formed in plural and pressed and laminated on the upper and lower sides of the coil 103 to implement the magnetic body 101.

The support member 102 may support the coil 103 and may be formed of polypropylene glycol (PPG), ferrite, or a metal-based soft magnetic member. As illustrated, a central portion of the support member 102 may be penetrated to form a through-hole, and the through-hole may be filled with the magnetic body 101 to form a magnetic core portion C.

The coil 103 may be disposed inside the body 101 and may perform various functions within an electronic device. For example, the magnetic component 100 may be a power inductor, in which case the coil 103 may store electricity in the form of a magnetic field to maintain an output voltage and stabilize power. In this case, the coil 103 may be laminated on each of opposite sides of the support member 102 and may be electrically connected through a conductive via V penetrating through the support member 102. The coil 103 may be formed in a spiral shape, and the outermost portion of the spiral shape may include a lead portion L exposed to the outside of the magnetic body 101 for electrical connection with the external electrodes 105 and 106.

The coil 103 is disposed on at least one of a first surface (an upper surface in FIG. 2) and a second surface (a lower surface in FIG. 2) that face each other on the support member 102. As in the present embodiment, a first coil 103a and a second coil 103b may be arranged on the first surface and the second surface of the support member 102, respectively, and in this case, the coil 103 may include a pad P. However, unlike this, the coil 103 may be disposed on only one surface of the support member 102. Meanwhile, a coil pattern forming the coil 103 may be formed using a plating process used in the art, such as pattern plating, anisotropic plating, or isotropic plating, and may be formed to have a multilayer structure using a plurality of these processes.

The external electrodes 105 and 106 may be formed on the outer surface of the magnetic body 101 and connected to the lead portion L. The external electrodes 105 and 106 may be formed using a paste including a metal having excellent electrical conductivity, and for example, it may be a conductive paste including nickel (Ni), copper (Cu), tin (Sn), or silver (Ag) alone, or alloys thereof. In addition, a plating layer may be further formed on the external electrodes 105 and 106. In this case, the plating layer may include at least one selected from the group consisting of nickel (Ni), copper (Cu), and tin (Sn), and for example, a nickel (Ni) layer and a tin (Sn) layer may be formed sequentially. In FIG. 1, the external electrodes 105 and 106 may have a form that extends from one side surface of the magnetic body 101 to the upper surface, lower surface, and the remaining side surface, but may also be implemented in various shapes, for example, may have an L-shape.

The plurality of first and second magnetic particles 111 and 121 included in the magnetic body 101 will be described in more detail. The first magnetic particle 111 may include an Fe-based alloy, for example, an Fe—Si—Cr-based alloy. The second magnetic particle 121 may include pure iron and may be in the form of, for example, carbonyl iron powder (CIP). As an example of a method for analyzing the components constituting the first magnetic particle 111 and the second magnetic particle 112 and the content of each component, transmission electron microscopy with energy dispersive spectroscopy (TEM-EDS) analysis may be used for a cross-section of the magnetic body 101. More specifically, the content of elements included in the first magnetic particle 111 and the second magnetic particle 112 may be obtained through an image obtained from the first direction-third direction (D1-D3) cross-section cut in the middle of the magnetic body 101 in the second direction D2 of the magnetic body 101 in FIG. 2, and may be an average value for the first magnetic particle 111 and the second magnetic particle 112. In addition, an average value may be calculated after performing this analysis process on a plurality of cross-sections of the magnetic body 101.

The first layer 112 of the first magnetic particle 111 may include an Fe oxide and may be necessary for the formation of the second layer 113. In this case, the first layer 112 of the first magnetic particle 111 may be a surface oxide film or a natural oxide film in which the surface of the first magnetic particle 111 is oxidized. A thickness t1 of the first layer 112 of the first magnetic particle 111 may be defined as a distance from the surface of the core of the first magnetic particle 111 to the surface of the first layer 112 and may correspond to an average thickness of thicknesses measured in a plurality of regions. The average thickness t1 of the first layer 112 may be obtained by obtaining an SEM or TEM image for at least one cross-section of the first magnetic particle 111 and then measuring a thickness of a plurality of regions at equal intervals. The first layer 112 of the first magnetic particle 111 may include at least one of an Fe—O-based material and an Fe—Si—O-based material, and for example, the first layer 112 may include Fe₂O₃. Unlike the second layer 113, even when the first layer 112 includes an Fe—Si—O-based material, it is preferable that Si be added in an extremely small amount. For example, the first layer 112 may include less than 1 wt % of the Si component. In addition, the first layer 112 may be formed in an amorphous structure, and thus, when the presence of the first layer 112 is analyzed, the first layer 112 may be analyzed through composition rather than analyzed structurally.

The first layer 112 of the first magnetic particle 111 may not be dense in structure, and thus, moisture and oxygen may continuously penetrate. In addition, according to research by the inventors of the present disclosure, the insulation in the magnetic body 101 may be more affected by the first magnetic particle 111 having a relatively large particle diameter. Considering this, in some embodiments, the second layer 113 including a Si oxide may be formed on the surface of the first layer 112 so that the insulation of the magnetic body 101 may be improved. The Si oxide of the second layer 113 may include SiO₂. In this case, the Si component may be included in an amount of 30 wt % to 70 wt % in the second layer 113 with respect to a total amount of the second layer. Since the second layer 113 may include a Si oxide, such as SiO₂, the insulation characteristics may be further improved and the layer may have a uniform thickness. In the case of insulating coating materials based on a Sn oxide and a P oxide, which have been commonly used in the related art, there are problems in that the uniformity of the coating layer thickness is low and withstand voltage characteristics are not sufficient. Accordingly, the second layer 113 of the first magnetic particle 111 may not include the Sn component or the P component. According to some embodiments, the insulating characteristics of the magnetic particle 111 may be improved by the second layer 113 including a Si oxide, and further, a saturation magnetization delay effect may be brought about. In addition, as an additional effect, the second layer 113 may have a strong bonding force with the insulating material 110 included in the magnetic body 101, so that high temperature and high humidity reliability may also be improved. According to some embodiments, when the average particle diameter d1 of the magnetic particle 111 is relatively large, such as 15 μm to 35 μm, the second layer 113 may exhibit even more improved effects in terms of characteristics, such as improved withstand voltage.

According to some example embodiments of a method of forming the second layer 113 of the first magnetic particle 111, a liquid coating method may be used. For example, a liquid coating method using tetraethyl orthosilicate (TEOS) may be used, and the second layer 113 may be uniformly coated at a level of several tens of nm through hydrolysis using ammonia water as a catalyst. As the second layer 113 is uniformly formed, the insulation of the first magnetic particle 111 may be obtained. Here, uniformity of the thickness of the second layer 113 may be defined as a value obtained by dividing the average of the absolute values of a difference from the average thickness t2 in a plurality of regions of the second layer 113 in a cross-section of the magnetic body 101 by the average thickness t2, and in the case of the present embodiment, the uniformity of the second layer 113 may be 90% or more, or even higher, 95%.

In the multilayer insulating structure of the first magnetic particles 111, the second layer 113 may be provided to secure more stable insulating characteristics, and an average thickness t2 may be about 5 nm to 35 nm. If the average thickness t2 of the second layer 113 is not sufficient, for example, less than about 5 nm, sufficient insulation may not be secured. In addition, if the average thickness t2 of the second layer 113 is excessively thick, for example, exceeding about 35 nm, the second layer 113 may excessively aggregate with another adjacent second layer 113. The thickness t2 of the second layer 113 may be defined as a distance from the surface of the first layer 112 to the surface of the second layer 113 and may correspond to an average thickness for thicknesses measured in a plurality of regions. The average thickness t2 of the second layer 113 may be obtained by an SEM or TEM image of at least one cross-section of the first magnetic particle 111 and then measuring thicknesses of a plurality of regions at equal intervals. The average thickness t2 of the second layer 113 may be thicker than the average thickness t1 of the first layer 112 and may be 2 to 10 times the average thickness t1 of the first layer 112.

Meanwhile, in the aforementioned example, the method of using SEM or TEM images to measure the thicknesses t1 and t2 of the first layer 112 and the second layer 113 of the first magnetic particle 111 has been described, but in addition, the thickness and constituent elements may also be analyzed through TEM-EDS analysis, and this analysis method may also be applied to the second magnetic particle 121. Specifically, after a sample of the magnetic component 100 is polished, a cross-section of the first magnetic particle 111 existing in the magnetic body 101 may be observed using a SEM, and a sample near the surface of the first magnetic particle 111 may be collected using a focused ion beam (FIB), and the first magnetic particle 111 and the insulating structures on the surface thereof may be observed under the conditions of a STEM magnification of X110K or more and an acceleration voltage of 200 kV. The magnetic particle and the insulating structures on the surface thereof were observed under the conditions of a STEM magnification of X110K or more and an acceleration voltage of 200 kV. From this, an EDS line profile scan may be performed from near the surface of the first magnetic particle 111 to the insulating structure (first layer and second layer), and the first layer 112 may be defined as a region from a portion in which the Fe component rapidly decreases to a portion in which the Si component rapidly increases. Also, the second layer 113 may be defined as a region from a portion in which the Si component increases rapidly to a portion in which the Si component decreases rapidly.

Referring to the insulating structure of the second magnetic particle 121, as described above, the first layer 122 may include a P oxide and, unlike the first magnetic particle 111, may have a single insulating structure. As described above, the first layer 122 of the second magnetic particle 121 may include a P oxide, and here, the P oxide may include phosphate. In the case of forming an insulating film, that is, the first layer 122, by treating the second magnetic particle 121 with phosphate, the natural oxide film existing on the surface of the second magnetic particle 121 may be removed. Since the second magnetic particle 121 having a relatively small particle diameter has a large specific surface area, the first layer 122 including a P oxide may be employed as an insulating film so that the wettability with the insulating material 110 of the magnetic body 101 may be excellent, thereby improving the structural stability of the magnetic body 101. An average thickness t3 of the first layer 122 of the second magnetic particles 121 may be about 5 nm to 15 nm. The average thickness t3 of the first layer 122 may be defined as a distance from the surface of the second magnetic particles 121 to the surface of the first layer 122 and may correspond to an average thickness for thicknesses measured in a plurality of regions. The average thickness t3 of the first layer 122 may be obtained by obtaining an SEM or TEM image for at least one cross-section of the second magnetic particles 121 and then measuring the thicknesses for a plurality of regions at equal intervals.

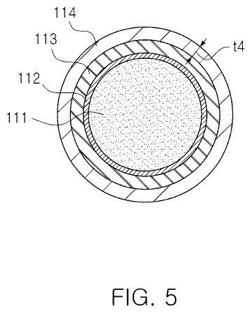

Hereinafter, another embodiments of the present disclosure will be described with reference to FIGS. 5 to 7. First, according to some embodiments, as illustrated in FIG. 5, an additional coating layer may be formed on the surface of the first magnetic particle 111. Specifically, the first magnetic particle 111 may further include a third layer 114 formed on the surface of the second layer 113, and here, the third layer 114 may be a surface treatment layer obtained by surface-treating the second layer 113. By the third layer 114 in the form of a surface treatment layer, the magnetic particle 111 may have a hydrophobic surface, and bonding strength with the insulating material 110 of the magnetic body 101 may be increased, thereby improving the reliability of the magnetic component 100. It is preferable to use a material having excellent bonding strength with the second layer 113 and the insulating material 110 as a surface treatment agent for the second layer 113 of the magnetic particle 111. For example, at least one of oleic acid or a silane coupling agent may be included, and a urethane silane coupling agent may be used as the silane coupling agent.

The third layer 114 may include a compound having at least one functional group of an alkyl group, a carbonyl group, or urethane acrylate. At this time, the functional group included in the third layer 114 may be detected using Fourier-transform infrared spectroscopy (FT-IR). When the first magnetic particles 111 include the third layer 114, which is a surface treatment layer, the magnetic body 101 may include at least of oleic acid, a derivative of oleic acid, carbonic acid, monoamide, N-allyl, or neopentyl ester. Here, the derivative of oleic acid may include at least one of oleic acid, methyl ester, butyl oleate, and oleic acid 3-hydroxypropyl ester. The above components included in the magnetic body 101 may be detected by gas chromatography-mass spectrometry (GC-MS). As described above, the third layer 114 may have the function of improving the bonding strength with the insulating material 110 within the magnetic body 101. However, if it becomes too thick, there is a possibility that the magnetic permeability of the magnetic body 101 may decrease, and thus, an average thickness t4 thereof may be less than 10 nm.

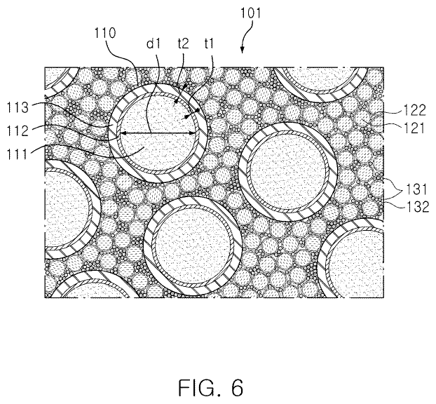

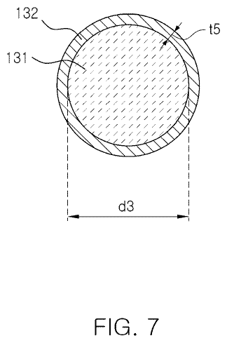

According to another embodiments of the present disclosure, as illustrated in FIGS. 6 and 7, the magnetic body 101 may include relatively small-sized third magnetic particles 121, and thus a packing ratio of the magnetic particles 111, 121, and 131 within the magnetic body 101 may be increased. Specifically, the magnetic body 101 may further include a plurality of third magnetic particles 131 having an average particle diameter d3 smaller than the average particle diameter d2 of the plurality of second magnetic particles 121. The third magnetic particles 131 may fill the space between the first magnetic particles 111 and the second magnetic particles 121 to increase the total amount of the magnetic particles 111, 121, and 131 present within the magnetic body 101. In this case, the average particle diameter d3 of the third magnetic particle 131 may be about 5 nm to 800 nm. The third magnetic particle 131 may include an Fe component and may be, for example, in the form of carbonyl iron powder (CIP). The first layer 132 may be formed as an insulating film on the surface of the third magnetic particle 131, and the first layer 132 of the third magnetic particle 131 may be an insulating film including a natural oxide film, a phosphate, or the like. The average thickness t5 of the first layer 132 of the third magnetic particle 131 may be about 3 nm or less, more specifically, about 1 nm or less.

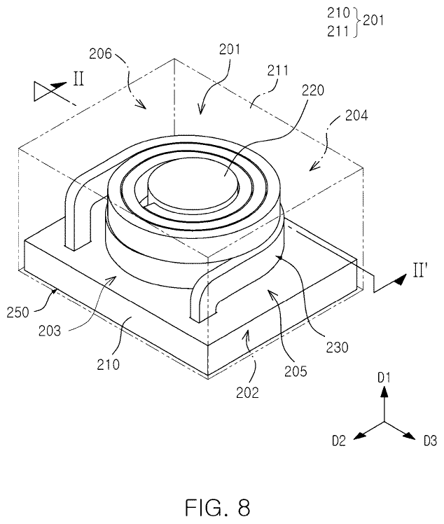

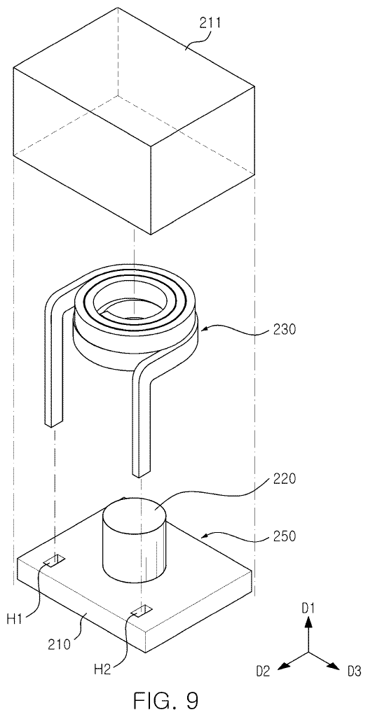

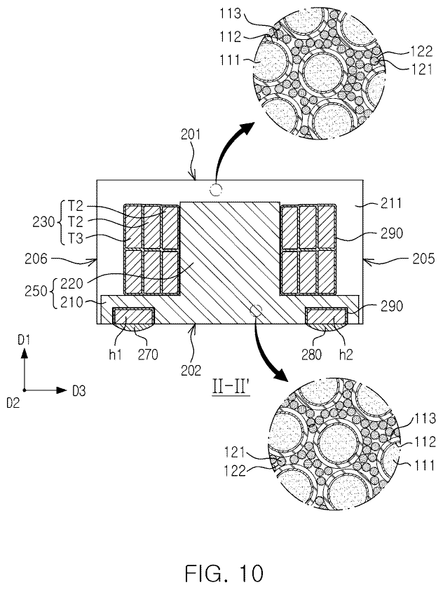

Another embodiment of the present disclosure will be described with reference to FIGS. 8 to 10. In the case of the previous embodiment, the coil 103 and the support member 102 supporting the coil are arranged in the magnetic body 101, and unlike this, in the embodiment of FIGS. 8 to 10, a wound coil is used. To describe this, a magnetic component 200 may include a molded portion 250, a coil 230, a cover portion 211, and accommodating recesses h1 and h2, and in addition, it may further include external electrodes 270 and 280. A magnetic body 201 may form an outer appearance of the magnetic component 200, and the coil 230 may be embedded in the magnetic body 201. The magnetic body 201 may include the molded portion 250 and the cover portion 211. The molded portion 250 may include a core 220. The magnetic body 201 may be formed in an overall hexahedral shape. The magnetic body 201 may include a first surface 201 and a second surface 202 opposing each other in the first direction D1, a third surface 203 and a fourth surface 204 opposing each other in the second direction D2, and a fifth surface 205 and a sixth surface 206 opposing each other in the third direction D3. Each of the third to sixth surfaces 203 to 206 of the magnetic body 201 may correspond to a wall surface of the magnetic body 201 connecting the first surface 201 and the second surface 202 of the magnetic body 201.

The magnetic body 201 may be formed, for example, for the magnetic component 200 according to the present embodiment in which the external electrodes 270 and 280 to be described below are formed to have a length of 2.0 mm, a width of 1.2 mm, and a thickness of 0.6 mm, but is not limited thereto. Meanwhile, the magnetic body 201 may include the molded portion 250 and the cover portion 211, and the cover portion 211 may be disposed above the molded portion 250 and surrounds all surfaces except a lower surface of the molded portion 250. The molded portion 250 may have one surface and the other surface opposing each other. One surface of the molded portion 250 may correspond to the lower surface of the molded portion 250 and refer to a region in which the accommodating recesses h1 and h2 to be described below are arranged. As described below, since the accommodating recesses h1 and h2 are processed inside the molded portion 250, a bottom surface of the accommodating recesses h1 and h2 may be disposed in a region between one surface and the other surface of the molded portion 250. The molded portion 250 may include a support portion 210 and the core 220. The core 220 may be disposed in the center of the other surface of the support portion 210 in a form that penetrates through the coil 230. The molded portion 250 may be formed by filling a mold with a composite material including the first magnetic particles 111, the second magnetic particles 121, and an insulating resin. Here, the insulating resin may include epoxy, polyimide, a liquid crystal polymer, or the like, alone or in combination, but is not limited thereto.

The coil 230 may be embedded in the magnetic body 201 and exhibit the characteristics of the magnetic component 200. For example, when the magnetic component 200 of the present embodiment is utilized as a power inductor, the coil 230 may store an electric field as a magnetic field to maintain an output voltage, thereby stabilizing power of an electronic device. The coil 230 is disposed on the other surface of the molded portion 250. Specifically, the coil 230 is disposed on the other surface of the support portion 210 in a form of winding around the core 220. The coil 230 may be an air-core coil and may be configured as a flat coil. The coil 230 may be formed by winding a metal wire, such as a copper wire, whose surface is coated with an insulating material, in a spiral shape. The coil 230 may include a plurality of layers. Each layer of the coil 230 may be formed in a flat spiral shape and may have a plurality of turns. That is, the coil 230 may include an innermost turn t1, at least one middle turn t2, and an outermost turn t3 from the center of one surface of the molded portion 250 to the outside.

The cover portion 211 may be disposed on the molded portion 250 and the coil 230. The cover portion 211 covers the molded portion 250 and the coil 230. The cover portion 211 may be disposed on the support portion 210 and the core 220 of the molded portion 250 and the coil 230 and then pressed to be coupled to the molded portion 250. The molded portion 250 and the cover portion 211 may each include the first magnetic particles 111 and the second magnetic particles 121. In this case, as described above, the plurality of first magnetic particles 111 having a relatively large size may include the first layer 112 formed on the surface and the second layer 113 formed on the surface of the first layer 112, and the plurality of second magnetic particles 121 may include the first layer 122 formed on the surface. In addition, the first layer 112 of the first magnetic particles 111 may include Fe oxide, and the second layer 113 of the first magnetic particles 111 may include Si oxide. In addition, the first layer 122 of the second magnetic particles 121 may include P oxide.

The first and second accommodating recesses h1 and h2 may be formed spaced apart from each other on one surface of the molded portion 250, and both end portions of the coil 230 described below are arranged in the first and second accommodating recesses h1 and h2. For example, the first and second accommodating recesses h1 and h2 are formed on one surface of the molded portion 250, respectively, and are spaced apart from each other in the length direction X. The first and second accommodating recesses h1 and h2 may be arranged on the outer side of the region corresponding to the core 220 in one surface of the molded portion 250, but are not limited thereto. The first and second accommodating recesses h1 and h2 may be formed to extend in one direction on one surface of the molded portion 250, but may be formed in any shape which is not limited as long as it has a structure of effectively exposing both end portions of the coil 230.

Since the magnetic body 201 is a region including the molded portion 250 and the cover portion 211, one surface of the magnetic body 201 refers to one surface of a region including the molded portion 250 and the cover portion 211. The coil 230 is drawn out and includes first and second lead portions arranged in first and second accommodating recesses h1 and h2, respectively. The first and second accommodating recesses h1 and h2 are regions for drawing out both end portions of the coil 230 to the external electrodes 270 and 280, and thus, the first and second accommodating recesses h1 and h2 are formed on one surface of the magnetic body 201 and spaced apart from each other to correspond to the first and second external electrodes 270 and 280, respectively.

As an example, through-recesses H1 and H2 may be formed by a mold when the molded portion 250 is formed, and the first and second accommodating recesses h1 and h2 may be formed in the molded portion 250 in a process of forming the cover portion 211 by laminating and pressing a magnetic sheet including magnetic metal particles. The mold for forming the molded portion 250 may include protrusions corresponding to the through-recesses H1 and H2, so that the through-recesses H1 and H2 may be formed in the molded portion 250 manufactured in a shape corresponding to the shape of the mold. In addition, the first and second accommodating recesses h1 and h2 may not be formed in the process of forming the molded portion 250, but may be formed in the process of forming the cover portion 211 on the molded portion 250. That is, both end portions of the coil portion 300 protruding from one surface of the molded portion 250 through the through-recesses H1 and H2 of the molded portion 250 may be embedded in the inside of the molded portion 250 in a magnetic sheet pressing process. As a result, the first and second accommodating recesses h1 and h2 may be formed on one surface of the molded portion 250. Alternatively, the first and second accommodating recesses h1 and h2 and the through-recesses H1 and H2 may be formed in the process of forming the molded portion 250 using a mold. In this case, the mold used to form the molded portion 250 may have protrusions formed to correspond to the first and second accommodating recesses h1 and h2 and the through-recesses H1 and H2.

Both end portions of the coil 230 may pass through one surface of the molded portion 250 so as to be disposed in the first and second accommodating recesses h1 and h2, respectively. A configuration in which the end portions of the coil 230 are disposed in the accommodating recesses h1 and h2 is not limited, and thus the widths of the first and second accommodating recesses h1 and h2 may be the same as or different from the widths of the through-recesses H1 and H2. Both end portions of the coil 230 are exposed to one surface of the molded portion 250, that is, the second surface 202 of the magnetic body 201. Both end portions of the coil 230 exposed to one surface of the molded portion 250 are disposed in the first and second accommodating recesses h1 and h2 formed to be spaced apart from each other on the second surface 202 of the magnetic body 201. Both end portions of the coil 230 may pass through the support portion 210 of the molded portion 250 and be exposed from one surface of the support portion 210. Although not specifically illustrated, since both end portions of the coil 230 have the same thickness as that of the coil 230, they may protrude from one surface of the support portion 210 by an amount corresponding to the thickness of the coil 230. However, the protruding end portions may also be polished together in the process of polishing openings of a plating resist for forming the external electrodes 270 and 280 described below, and thus, the end portions of the coil 230 exposed from one surface of the support portion 210 may be substantially smaller than the thickness of the coil 230.

The external electrodes 270 and 280 may be spaced apart from each other on one surface of the magnetic body 201, i.e., the second surface 202. Specifically, the external electrodes 270 and 280 may be spaced apart from each other on one surface of the molded portion 250 and may be respectively connected to both end portions of the coil 230 disposed in the first and second accommodating recesses h1 and h2. Since both end portions of the coil 230 are arranged on the bottom surfaces of the first and second accommodating recesses h1 and h2 and the external electrodes 270 and 280 are applied along the both end portions of the coil 230, the external electrodes may be formed to correspond to the shapes of the first and second accommodating recesses h1 and h2. As an example, the external electrodes 270 and 280 may be formed by applying a conductive resin including conductive powder, such as silver (Ag), onto the first and second accommodating recesses h1 and h2. The external electrodes 270 and 280 may be formed of a conductive material, such as copper (Cu), aluminum (Al), silver (Ag), tin (Sn), gold (Au), nickel (Ni), lead (Pb), chromium (Cr), titanium (Ti), or alloys thereof, but are not limited thereto. The external electrodes 270 and 280 may be formed in a single-layer or multi-layer structure.

Meanwhile, the magnetic component 200 according to the present embodiment may further include an insulating layer 290 surrounding the surface of the coil 230. There is no limitation on the method of forming the insulating layer 290, but for example, the insulating layer 290 may be formed by chemical vapor deposition of a parylene resin or the like on the surface of the coil 230 or may be formed by a known method, such as screen printing, a process of exposing and developing photoresist (PR), spray application, or a dipping process. The insulating layer 290 is not particularly limited as long as it may be formed as a thin film, but may be formed to include, for example, photoresist (PR), epoxy resin, etc.

In the case of the magnetic component according to an example of the present disclosure, the eddy current loss characteristics, structural stability, etc. of the magnetic body including magnetic particles may be improved.

While example embodiments have been illustrated and described above, it will be apparent to those skilled in the art that modifications and variations could be made without departing from the scope of the present disclosure as defined by the appended claims.

What is claimed is:

1. A magnetic component comprising a magnetic body,
wherein the magnetic body includes a plurality of first magnetic particles including an Fe component and a plurality of second magnetic particles including an Fe component and having an average particle diameter smaller than an average particle diameter of the plurality of first magnetic particles,
at least one of the plurality of first magnetic particles includes a first layer formed on a surface of a core of the plurality of first magnetic particles and a second layer formed on a surface of the first layer,
at least some of the plurality of second magnetic particles include a first layer formed on a surface of a core of the plurality of second magnetic particles,
the first layer of the plurality of first magnetic particles includes an Fe oxide, the second layer of the plurality of first magnetic particles includes a Si oxide, and
the first layer of the plurality of second magnetic particles includes a P oxide.

2. The magnetic component of claim 1, wherein an average particle diameter of the plurality of first magnetic particles is 15 μm to 35 μm.

3. The magnetic component of claim 1, wherein an average thickness of the second layer of the plurality of first magnetic particles is 5 nm to 35 nm.

4. The magnetic component of claim 1, wherein the first layer of the plurality of first magnetic particles includes less than 1 wt % of a Si component.

5. The magnetic component of claim 1, wherein the second layer of the plurality of first magnetic particles includes 30 to 70 wt % of a Si component.

6. The magnetic component of claim 1, wherein the second layer of the plurality of first magnetic particles does not include a Sn component.

7. The magnetic component of claim 1, wherein an average particle diameter of the plurality of second magnetic particles is 0.9 μm to 4.5 μm.

8. The magnetic component of claim 1, wherein an average thickness of the first layer of the plurality of second magnetic particles is 5 nm to 15 nm.

9. The magnetic component of claim 1, wherein the first layer of the plurality of second magnetic particles includes phosphate.

10. The magnetic component of claim 1, wherein the plurality of first magnetic particles further include a third layer formed on a surface of the second layer.

11. The magnetic component of claim 10, wherein the third layer includes a compound having at least one functional group selected from the group consisting of an alkyl group, a carbonyl group, and a urethane acrylate.

12. The magnetic component of claim 11, wherein an average thickness of the third layer is less than 10 nm.

13. The magnetic component of claim 1, wherein the plurality of first magnetic particles include an Fe—Si—Cr alloy.

14. The magnetic component of claim 1, wherein the magnetic body includes an Fe component and further includes a plurality of third magnetic particles having an average particle diameter smaller than an average particle diameter of the plurality of second magnetic particles.

15. The magnetic component of claim 14, wherein the average particle diameter of the plurality of third magnetic particles is 5 nm to 800 nm.

16. A magnetic component comprising a magnetic body,
wherein the magnetic body includes a plurality of first magnetic particles including an Fe component and a plurality of second magnetic particles including an Fe component and having an average particle diameter smaller than an average particle diameter of the plurality of first magnetic particles,
at least one of the plurality of first magnetic particles includes a first layer formed on a surface of a core of the plurality of first magnetic particles and a second layer formed on a surface of the first layer,
at least some of the plurality of second magnetic particles include a first layer formed on a surface of a core of the plurality of second magnetic particles,
the first layer of the plurality of first magnetic particles includes an Fe oxide, the second layer of the plurality of first magnetic particles is substantially free from the Fe oxide,
the plurality of second magnetic particles does not include a second layer disposed on the first layer.

17. The magnetic component of claim 16, wherein the second layer of the plurality of first magnetic particles includes a Si oxide.

18. The magnetic component of claim 16, wherein the first layer of the plurality of second magnetic particles includes a P oxide.

19. The magnetic component of claim 16, wherein an average particle diameter of the plurality of first magnetic particles is 15 μm to 35 μm.

20. The magnetic component of claim 16, wherein an average thickness of the second layer of the plurality of first magnetic particles is 5 nm to 35 nm.
